(19) United States
(12) Patent Application Publication
(10) Pub. No.: US 2023/0389063 A1
(43) Pub. Date: Nov. 30, 2023

(54) SYSTEMS AND METHODS OF ACCESS POINT-ASSISTED TXOP SHARING FOR TRAFFIC COORDINATION

(71) Applicant: Meta Platforms Technologies, LLC, Menlo Park, CA (US)

(72) Inventors: Neelakantan Nurani Krishnan, San Jose, CA (US); Guoqing Li, Cupertino, CA (US); Dong Zheng, Saratoga, CA (US); Qi Qu, Redmond, WA (US)

(21) Appl. No.: 17/739,957

(22) Filed: May 9, 2022

(51) Int. Cl. H04W 72/12; H04W 52/02; H04W 74/08

(52) U.S. Cl. CPC H04W 72/1231; H04W 52/0216; H04W 74/0808; H04W 72/121

(57) ABSTRACT

Disclosed herein are systems and methods directed to sending, by a first wireless communication device to a second wireless communication device, a stream classification service (SCS) request frame including information of traffic to be communicated between the first wireless communication device and a third wireless communication device. The first wireless communication device, the second wireless communication device and the third wireless communication device share a wireless communication channel. The method can include communicating, by the first wireless communication device responsive to receiving an indication that a transmission opportunity (TXOP) of the second wireless communication device is shared with the first wireless communication device, with the second wireless communication device on a first link during a first portion of the TXOP, and with the third wireless communication device on a second link during a second portion of the TXOP.

### FIELD OF DISCLOSURE

The present disclosure is generally related to coordinating traffic between devices communicating on the same wireless channel, including but not limited to reducing interference in communication for artificial reality and other applications.

### BACKGROUND

Artificial reality such as a virtual reality (VR), an augmented reality (AR), or a mixed reality (MR) provides immersive experience to a user. In one example, a user wearing a head wearable display (HWD) can turn the user's head, and an image of a virtual object corresponding to a location of the HWD and a gaze direction of the user can be displayed on the HWD to allow the user to feel as if the user is moving within a space of artificial reality (e.g., a VR space, an AR space, or a MR space). An image of a virtual object may be generated by a computing device communicatively coupled to the HWD. In some embodiments, the computing device may have access to a network.

In one implementation, an image of a virtual object is generated by a console communicatively coupled to the HWD. In one example, the HWD includes various sensors that detect a location and/or orientation of the HWD, and transmits the detected location and/or orientation of the HWD to the console through a wired connection or a wireless connection. The console can determine a user's view of the space of the artificial reality according to the detected location and/or orientation of the HWD, and generate image data indicating an image of the space of the artificial reality corresponding to the user's view. The console can transmit the image data to the HWD, by which the image of the space of the artificial reality corresponding to the user's view can be presented to the user. In one aspect, the process of detecting the location of the HWD and the gaze direction of the user wearing the HWD, and rendering the image to the user should be performed within a frame time (e.g., less than 11 ms). Any latency caused by interference between a movement of the user wearing the HWD and an image displayed corresponding to the user movement can cause judder, which may result in motion sickness and can degrade the user experience.

### SUMMARY

Disclosed herein are systems and methods related to coordinating traffic between devices communicating on the same wireless channel. Some embodiments are related to a method of sending, by a first wireless communication device (e.g., computing device, soft access point) to a second wireless communication device (e.g., access point), a stream classification service (SCS) request frame including information of traffic to be communicated between the first wireless communication device and a third wireless communication device (e.g., head wearable device, smart glasses). The first wireless communication device, the second wireless communication device and the third wireless communication device can share a wireless communication channel. The method can include communicating, by the first wireless communication device responsive to receiving an indication that a transmission opportunity (TXOP) of the second wireless communication device is shared with the first wireless communication device, with the second wireless communication device on a first link during a first portion of the TXOP, and with the third wireless communication device on a second link (e.g., on the same wireless communication channel as the first link) during a second portion of the TXOP.

The method may include determining, by the first wireless communication device in communication with the second wireless communication device, a target wake time (TWT) schedule. The method may include determining, by the first wireless communication device in communication with the third wireless communication device, a wake up schedule. The first wireless communication device may determine the TWT schedule according to (e.g., to align with, or to accommodate) the wake up schedule. The indication may comprise a multi-user request to send a TXOP sharing (MU-RTS TXS) frame (e.g., of mode 2). The method may also include receiving, by the first wireless communication device, from the second wireless communication device, a message including an enhanced distribution channel access (EDCA) timer value for the first wireless communication device; and/or refraining from contending for the wireless communication channel, by the first wireless communication device, according to the EDCA timer value. The method may include triggering by the first wireless communication device, the third wireless communication device via a message, the message communicated to the third wireless communication device during the TXOP. The message may comprise one of an MU-RTS TXS frame (e.g., of mode 1), a trigger based physical layer protocol data unit (PPDU), a single user PPDU with a set reverse direction grant (RDG) bit, or an orthogonal frequency division multiple access (OFDMA) PPDU embedded basic trigger. The first portion of the TXOP may occur at a time before the second portion of the TXOP. The second portion of the TXOP may occur at a time before the first portion of the TXOP.

Other embodiments are related to a wireless communication device comprising a transceiver; and at least one processor configured to: send, via the transceiver, a stream classification service (SCS) request frame to a second wireless communication device including information of traffic to be communicated between the wireless communication device and a third wireless communication device, wherein the wireless communication device, the second wireless communication device, and the third wireless communication device can share a wireless communication channel; and/or communicate, responsive to receiving an indication that a transmission opportunity (TXOP) of the second wireless communication device is shared with the wireless communication device, via the transceiver with the second wireless communication device on a first link during a first portion of the TXOP, and/or with the third wireless communication device on a second link during a second portion of the TXOP.

The at least one processor may be configured to determine a target wake time (TWT) schedule with the second wireless communication device. The at least one processor may be configured to determine a wake up schedule with the third wireless communication device. The at least one processor may be configured to determine the TWT schedule according to the wake up schedule. The indication may comprise a multi-user request to send TXOP sharing (MU-RTS TXS) frame (e.g., of mode 2). The at least one processor may be configured to receive, via the transceiver from the second wireless communication device, a message including an enhanced distribution channel access (EDCA) timer value for the wireless communication device; and/or can refrain from contending for the wireless communication channel, according to the EDCA timer value. The at least one processor may be configured to trigger the third wireless communication device via a message sent via the transceiver, the message communicated to the third wireless communication device during the TXOP. The message may include one of an MU-RTS TXS frame (e.g., of mode 1), a trigger based physical layer protocol data unit (PPDU), a single user PPDU with a set reverse direction grant (RDG) bit, or an orthogonal frequency division multiple access (OFDMA) PPDU embedded basic trigger. The first portion of the TXOP can occur at a time before the second portion of the TXOP, or, the second portion of the TXOP can occur at a time before the first portion of the TXOP.

Other embodiments are related to a non-transitory processor-readable medium containing processor-readable instructions, such that, when executed by one or more processors of a wireless communication device, cause the one or more processors to: send, via a transceiver, a stream classification service (SCS) request frame to a second wireless communication device including information of traffic to be communicated between the wireless communication device and a third wireless communication device, wherein the wireless communication device, the second wireless communication device, and the third wireless communication device can share a wireless communication channel; and communicate, responsive to receiving an indication that a transmission opportunity (TXOP) of the second wireless communication device is shared with the wireless communication device, via the transceiver with the second wireless communication device on a first link during a first portion of the TXOP, and with the third wireless communication device on a second link during a second portion of the TXOP.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment, according to an example implementation of the present disclosure.

FIG. 4 is a timing diagram 400 showing a wake-up/sleep schedule of a computing device utilizing TWT, according to an example implementation of the present disclosure.

FIG. 5 illustrates an interaction/flow diagram showing a process of coordinating traffic of multiple devices sharing the same wireless communication channel, according to an example implementation of the present disclosure.

FIG. 6 illustrates an interaction diagram showing a process of coordinating intralink and interlink communication within one TXOP through TXOP sharing, according to an example implementation of the present disclosure.

FIG. 7 illustrates another interaction diagram showing a process 700 of coordinating intralink and interlink communication within one TXOP through TXOP sharing, according an example implementation of the present disclosure.

FIGS. 8-11 illustrate different ways in which the computing device 110 and HWD 150 may coordinate traffic during intralink communication, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Disclosed herein are related to systems and methods for coordinating traffic between devices communicating on the same wireless channel (e.g., single channel concurrency (SCC)). Coordinating traffic may result in predictable data transmissions such that devices may enter low power/idle/sleep modes in a coordinated, more power efficient manner. Coordinating traffic between devices and improving the predictability of traffic can improve the performance of low power (or battery operated) devices. In particular, there is a need for coordinating traffic between devices when such devices are executing latency sensitive applications such as remote rendering of an artificial reality space (e.g., an AR space, a VR space, or a MR space) or other wireless communication applications.

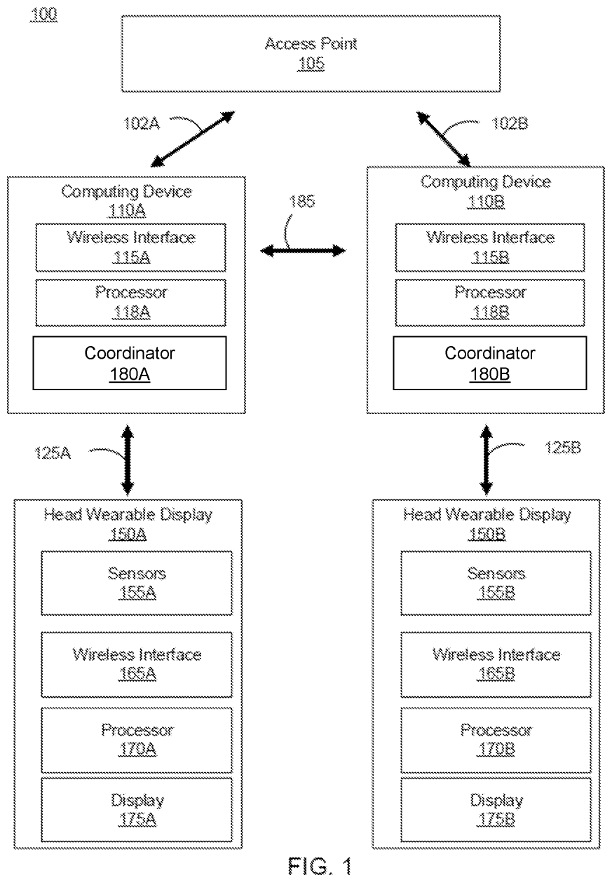

FIG. 1 is a block diagram of an example artificial reality system environment 100. In some embodiments, the artificial reality system environment 100 includes an access point (AP) 105, one or more HWDs 150 (e.g., HWD 150A, 150B), and one or more computing devices 110 (computing devices 110A, 110B) providing data for artificial reality to the one or more HWDs 150. The access point 105 may be a router or any network device allowing one or more computing devices 110 and/or one or more HWDs 150 to access a network (e.g., the Internet). The access point 105 may be replaced by any communication device (cell site). A computing device 110 may be a computing device or a mobile device that can retrieve content from the access point 105, and can provide image data of artificial reality to a corresponding HWD 150. Each HWD 150 may present the image of the artificial reality to a user according to the image data. In some embodiments, the artificial reality system environment 100 includes more, fewer, or different components than shown in FIG. 1. In some embodiments, the computing devices 110A, 110B communicate with the access point 105 through wireless links 102A, 102B (referred to herein as wireless link 102) respectively. The communication between the AP 105 and computing device 110 may be considered “interlink communication” or “infrastructure traffic,” in which the AP 105 and the computing devices 110 communicate using an infrastructure link/AP link 102. In some embodiments, the computing device 110A communicates with the HWD 150A, HWD 150B through wireless links 125A, 125B (referred to herein as wireless link 125) respectively. The communication between the computing devices 110 and the HWDs 150 may be considered “intralink communication” (e.g., a peer-to-peer link) or “non-infrastructure traffic”. In some embodiments, functionality of one or more components of the artificial reality system environment 100 can be distributed among the components in a different manner than is described here. For example, some of the functionality of the computing device 110 may be performed by the HWD 150. Additionally or alternatively, some of the functionality of the HWD 150 may be performed by the computing device 110.

In some embodiments, the HWD 150 is an electronic component that can be worn by a user and can present or provide an artificial reality experience to the user. The HWD 150 may be referred to as, include, or be part of a head mounted display (HMD), head mounted device (HMD), head wearable device (HWD), head worn display (HWD) or head worn device (HWD). The HWD 150 may render one or more images, video, audio, or some combination thereof to provide the artificial reality experience to the user. In some embodiments, audio is presented via an external device (e.g., speakers and/or headphones) that receives audio information from the HWD 150, the computing device 110, or both, and presents audio based on the audio information. In some embodiments, the HWD 150 includes sensors 155, a wireless interface 165, a processor 170, and a display 175. These components may operate together to detect a location of the HWD 150 and a gaze direction of the user wearing the HWD 150, and render an image of a view within the artificial reality corresponding to the detected location and/or orientation of the HWD 150. In other embodiments, the HWD 150 includes more, fewer, or different components than shown in FIG. 1.

In some embodiments, the sensors 155 include electronic components or a combination of electronic components and software components that detects a location and an orientation of the HWD 150. Examples of the sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and the rotational movement, and determine an orientation and location of the HWD 150. In one aspect, the sensors 155 can detect the translational movement and the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the wireless interface 165 includes an electronic component or a combination of an electronic component and a software component that communicates with the computing device 110. In some embodiments, the wireless interface 165 includes or is embodied as a transceiver for transmitting and receiving data through a wireless medium. The wireless interface 165 may communicate with a wireless interface 115 of a corresponding computing device 110 through a wireless link 125 (e.g., intralink communication). The wireless interface 165 may also communicate with the access point 105 through a wireless link (e.g., interlink communication). Examples of the wireless link 125 include a near field communication link, Wi-Fi direct, Bluetooth, or any wireless communication link. Through the wireless link 125, the wireless interface 165 may transmit to the computing device 110 data indicating the determined location and/or orientation of the HWD 150, the determined gaze direction of the user, and/or hand tracking measurement. Moreover, through the wireless link 125, the wireless interface 165 may receive from the computing device 110 image data indicating or corresponding to an image to be rendered.

In some embodiments, the processor 170 includes an electronic component or a combination of an electronic component and a software component that generates one or more images for display, for example, according to a change in view of the space of the artificial reality. In some embodiments, the processor 170 is implemented as one or more graphical processing units (GPUs), one or more central processing unit (CPUs), or a combination of them that can execute instructions to perform various functions described herein. The processor 170 may receive, through the wireless interface 165, image data describing an image of artificial reality to be rendered, and render the image through the display 175. In some embodiments, the image data from the computing device 110 may be encoded, and the processor 170 may decode the image data to render the image. In some embodiments, the processor 170 receives, from the computing device 110 through the wireless interface 165, object information indicating virtual objects in the artificial reality space and depth information indicating depth (or distances from the HWD 150) of the virtual objects. In one aspect, according to the image of the artificial reality, object information, depth information from the computing device 110, and/or updated sensor measurements from the sensors 155, the processor 170 may perform shading, reprojection, and/or blending to update the image of the artificial reality to correspond to the updated location and/or orientation of the HWD 150.

In some embodiments, the display 175 is an electronic component that displays an image. The display 175 may, for example, be a liquid crystal display or an organic light emitting diode display. The display 175 may be a transparent display that allows the user to see through. In some embodiments, when the HWD 150 is worn by a user, the display 175 is located proximate (e.g., less than 3 inches) to the user's eyes. In one aspect, the display 175 emits or projects light towards the user's eyes according to image generated by the processor 170. The HWD 150 may include a lens that allows the user to see the display 175 in a close proximity.

In some embodiments, the processor 170 performs compensation to compensate for any distortions or aberrations. In one aspect, the lens introduces optical aberrations such as a chromatic aberration, a pin-cushion distortion, barrel distortion, etc. The processor 170 may determine a compensation (e.g., predistortion) to apply to the image to be rendered to compensate for the distortions caused by the lens, and apply the determined compensation to the image from the processor 170. The processor 170 may provide the predistorted image to the display 175.

In some embodiments, the computing device 110 is an electronic component or a combination of an electronic component and a software component that provides content to be rendered to the HWD 150. The computing device 110 may be embodied as a mobile device (e.g., smart phone, tablet PC, laptop, etc.). The computing device 110 may operate as a soft access point. In one aspect, the computing device 110 includes a wireless interface 115 and a processor 118. These components may operate together to determine a view (e.g., a field of view of the user) of the artificial reality corresponding to the location of the HWD 150 and the gaze direction of the user of the HWD 150, and can generate image data indicating an image of the artificial reality corresponding to the determined view. The computing device 110 may also communicate with the access point 105, and may obtain AR/VR content from the access point 105, for example, through the wireless link 102 (e.g., interlink). The computing device 110 may receive sensor measurement indicating location and the gaze direction of the user of the HWD 150 and provide the image data to the HWD 150 for presentation of the artificial reality, for example, through the wireless link 125 (e.g., intralink communication). In other embodiments, the computing device 110 includes more, fewer, or different components than shown in FIG. 1.

In some embodiments, the wireless interface 115 is an electronic component or a combination of an electronic component and a software component that communicates with the HWD 150, the access point 105, other computing device 110, or any combination of them. In some embodiments, the wireless interface 115 includes or is embodied as a transceiver for transmitting and receiving data through a wireless medium. The wireless interface 115 may be a counterpart component to the wireless interface 165 to communicate with the HWD 150 through a wireless link 125 (e.g., intralink communication). The wireless interface 115 may also include a component to communicate with the access point 105 through a wireless link 102 (e.g., interlink communication). Examples of wireless link 102 include a cellular communication link, a near field communication link, Wi-Fi, Bluetooth, 60 GHz wireless link, or any wireless communication link. The wireless interface 115 may also include a component to communicate with a different computing device 110 through a wireless link 185. Examples of the wireless link 185 include a near field communication link, Wi-Fi direct, Bluetooth, or any wireless communication link. Through the wireless link 102 (e.g., interlink communication), the wireless interface 115 may obtain AR/VR content, or other content from the access point 105. Through the wireless link 125 (e.g., intralink communication), the wireless interface 115 may receive from the HWD 150 data indicating the determined location and/or orientation of the HWD 150, the determined gaze direction of the user, and/or the hand tracking measurement. Moreover, through the wireless link 125 (e.g., intralink communication), the wireless interface 115 may transmit to the HWD 150 image data describing an image to be rendered. Through the wireless link 185, the wireless interface 115 may receive or transmit information indicating the wireless link 125 (e.g., channel, timing) between the computing device 110 and the HWD 150. According to the information indicating the wireless link 125, computing devices 110 may coordinate or schedule operations to avoid interference or collisions.

The processor 118 can include or correspond to a component that generates content to be rendered according to the location and/or orientation of the HWD 150. In some embodiments, the processor 118 includes or is embodied as one or more central processing units, graphics processing units, image processors, or any processors for generating images of the artificial reality. In some embodiments, the processor 118 may incorporate the gaze direction of the user of the HWD 150 and a user interaction in the artificial reality to generate the content to be rendered. In one aspect, the processor 118 determines a view of the artificial reality according to the location and/or orientation of the HWD 150. For example, the processor 118 maps the location of the HWD 150 in a physical space to a location within an artificial reality space, and determines a view of the artificial reality space along a direction corresponding to the mapped orientation from the mapped location in the artificial reality space. The processor 118 may generate image data describing an image of the determined view of the artificial reality space, and transmit the image data to the HWD 150 through the wireless interface 115. The processor 118 may encode the image data describing the image, and can transmit the encoded data to the HWD 150. In some embodiments, the processor 118 generates and provides the image data to the HWD 150 periodically (e.g., every 11 ms or 16 ms).

In some embodiments, the processors 118 may configure or cause the wireless interfaces 115 to toggle, transition, cycle or switch between a sleep mode and a wake up mode. In the wake up mode, the processor 118 may enable the wireless interface 115 such that the wireless interfaces 115 may exchange data. In the sleep mode, the processor 118 may disable the wireless interface 115 (e.g., may implement low power or reduced operation) such that the wireless interfaces 115 may not consume power, or may reduce power consumption. The processors 118 may schedule the wireless interfaces 115 to switch between the sleep mode and the wake up mode periodically every frame time (e.g., 11 ms or 16 ms). For example, the wireless interfaces 115 may operate in the wake up mode for 2 ms of the frame time, and the wireless interfaces 115 may operate in the sleep mode for the remainder (e.g., 9 ms) of the frame time. By disabling the wireless interfaces 115 in the sleep mode, power consumption of the computing device 110 and the HWD 150 can be reduced or minimized.

In some embodiments, the processors 118 may configure or cause the wireless interfaces 115 to resume communication based on stored information indicating communication between the computing device 110 and the HWD 150. In the wake up mode, the processors 118 may generate and store information (e.g., channel, timing) of the communication between the computing device 110 and the HWD 150. The processors 118 may schedule the wireless interfaces 115 to enter a subsequent wake up mode according to timing of the previous communication indicated by the stored information. For example, the wireless interfaces 115 may predict/determine when to enter the subsequent wake up mode, according to timing of the previous wake up mode, and can schedule to enter the subsequent wake up mode at the predicted time. After generating and storing the information and scheduling the subsequent wake up mode, the processors 118 may configure or cause the wireless interfaces 115 to enter the sleep mode. When entering the wake up mode, the processors 118 may cause or configure the wireless interfaces 115 to resume communication via the channel or frequency band of the previous communication indicated by the stored information. Accordingly, the wireless interfaces 115 entering the wake up mode from the sleep mode may resume communication, while bypassing a scan procedure to search for available channels and/or performing handshake or authentication. Bypassing the scan procedure allows extension of a duration of the wireless interfaces 115 operating in the sleep mode, such that the computing device 110 and the HWD 150 can reduce power consumption.

In some embodiments, the computing devices 110A, 110B may coordinate operations to reduce collisions or interferences. In one approach, the computing device 110A may transmit a beacon frame periodically to announce/advertise a presence of a wireless link 125A between the computing device 110A and the HWD 150A and can coordinate the communication between the computing device 110A and the HWD 150A. The computing device 110B may monitor for or receive the beacon frame from the computing device 110A, and can schedule communication with the HWD 150B (e.g., using information in the beacon frame, such as an offset value) to avoid collision or interference with communication between the computing device 110A and the HWD 150A. For example, the computing device 110B may schedule the computing device 110B and the HWD 150B to enter a wake up mode, when the computing device 110A and the HWD 150A operate in the sleep mode. For example, the computing device 110B may schedule the computing device 110B and the HWD 150B to enter a sleep up mode, when the computing device 110A and the HWD 150A operate in the wake up mode. Accordingly, multiple computing devices 110 and HWDs 150 in proximity (e.g., within 20 ft) may coexist and operate with reduced interference.

In some embodiments, a coordinator 180 (e.g., coordinator 180A of the computing device 110A and/or coordinator 180B of the computing device 110B) may coordinate traffic communicated on wireless link 125 (intralink communication) and wireless link 102 (interlink communication). To coordinate traffic of the three devices (e.g., computing device 110, HWDs 150, and AP 105), the coordinator 180 may coordinate (request, communicate), with the AP 105 using wireless link 102, traffic information to be communicated between the computing devices 110 and the HWDs 150 on wireless link 125. The traffic information to be communicated may include delay/latency/prioritization information, throughput information, tolerable packet loss, a size of the traffic to be communicated, a duration of the traffic to be communicated, orientation/motion data such as inertial measurement unit (IMU) data, etc.

Using the information received from the coordinator 180, the AP 105 may determine a duration of time to allot/allocate/assign for the transmission opportunity (TXOP). The TXOP may be the duration of time for which a device can use a medium for data transfer. For example, the AP 105 may receive information about the traffic to be communicated between the computing devices 110 and the HWDs 150 on wireless link 125 and the AP 105 may know/project/estimate the traffic to be communicated between the computing devices 110 and the AP 105. Accordingly, the AP 105 may determine a total time to allot for the transmission opportunity based on the traffic information to be communicated between the computing devices 110 and the HWDs 150 on wireless link 125 and the traffic to be communicated between the computing devices 110 and the AP 105.

The coordinator 180 may also coordinate/communicate traffic in response to receiving an indication from the AP 105. The AP 105 may contend for the medium (e.g., the wireless channel that is shared to create/support wireless link 102, wireless link 185, and/or wireless link 125). The AP 105 may communicate during a TXOP and subsequently can share any remaining time of the TXOP with the computing device 110 (e.g., the coordinator 180). As described herein, the remaining time of the TXOP (e.g., the duration of the shared TXOP) is the time requested/coordinated by the computing device 110. For example, the computing device 110 may have indicated the traffic information to be communicated to the AP 105 such that the remaining time of the TXOP is the time for the intralink data transfer (e.g., between the computing device 110 and the HWD 150).

In an example implementation, in response to receiving a message from the AP 105 that the AP is to share (or is sharing) a portion of the TXOP, the coordinator 180 may communicate uplink traffic to the AP 105 using wireless link 102 (e.g., interlink communication) and/or communicate downlink traffic to the HWD 150s using wireless link 125 (e.g., intralink communication). In some embodiments, the traffic communicated downlink to the HWDs 150 may be data/content. In some embodiments, the traffic to be communicated downlink to the HWDs 150 may be control information (or information that is not data/content). The control information may be used to solicit data/content from the HWDs 150.

The coordinator 180 may coordinate (e.g., align, arrange, schedule) sleep schedules (or wake up schedules). The coordinator 180 may coordinate one or more wake up schedules with the HWDs 150 and/or AP 105. In an example implementation, the coordinator 180 may coordinate a wake up schedule with the HWD 150. The coordinator 180 may use the wake up schedule associated with the HWD 150 to determine a wake up schedule associated with the AP 105. For example, depending on the traffic information to be communicated to the AP 105 and/or HWD 150 (e.g., the size of the traffic to be communicated, the duration of the traffic to be communicated), the coordinator 180 (or computing device 110) may wake up a duration of time before the wake up schedule associated with the HWD 150. In a non-limiting example, if the coordinator 180 (or computing device 110) knows/determines that it is to communicate 10 ms of traffic to the AP 105 and Ems of traffic to HWD 150A, the coordinator 180 (or computing device 110) may wake up 10 ms before the HWD 150A such that the coordinator (or computing device 110) can communicate the 10 ms traffic with the AP 105 before the HWD 150A wakes up. After the computing device 110 communicates the 10 ms of traffic with the AP 105, the HWD 150A may wake up. Accordingly, the computing device 110 may communicate the 6 ms of traffic with the HWD 150A.

The coordinator 180 may coordinate one or more parameters associated with the wireless channel. For example, the coordinator 180 may extract/parse/store one or more enhanced distribution channel access (EDCA) parameters. The coordinator 180 may coordinate with the computing device 110 to act/operate according to the one or more parameters associated with the wireless channel. For example, the coordinator 180 may cause the computing device 110 to refrain from contending for the wireless communication channel according to an EDCA timer value (e.g., an MU-EDA timer value that is configured/set by the AP for the computing device 110, and sent by the AP to the computing device 110). The computing device 110 (e.g., coordinator 180) may configure/set an EDCA timer value for the HWD 150A, to cause the HWD 150A to refrain from contending for the wireless communication channel.

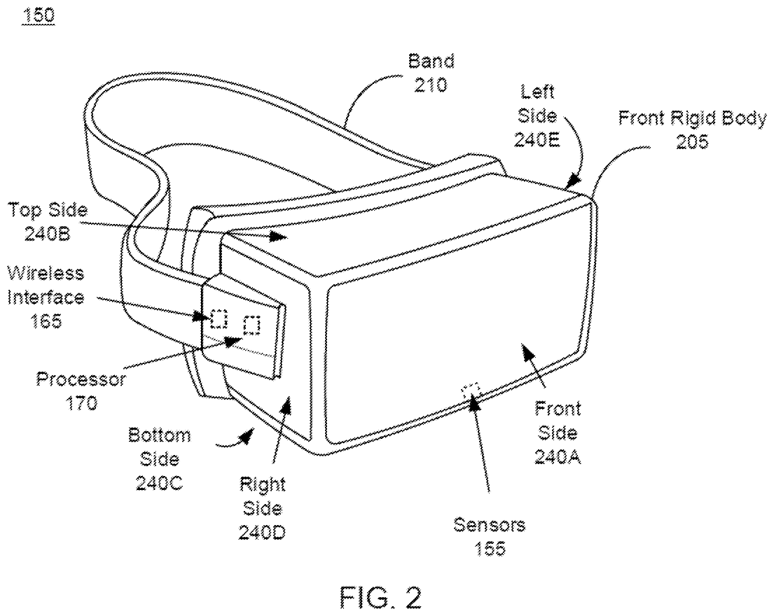

FIG. 2 is a diagram of a HWD 150, in accordance with an example embodiment. In some embodiments, the HWD 150 includes a front rigid body 205, a left side 240E, a front side 240A, a right side 240D, a bottom side 240C, a top side 240B, and a band 210. The front rigid body 205 includes the electronic display 175 (not shown in FIG. 2), the lens 180 (not shown in FIG. 2), the sensors 155, the eye trackers 160A, 160B, (not shown) the communication interface (wireless interface) 165, and the processor (image renderer) 170. In the embodiment shown by FIG. 2, the communication interface 165, the image renderer 170, and the sensors 155 are located within the front rigid body 205, and may not visible to the user. In other embodiments, the HWD 150 has a different configuration than shown in FIG. 2. For example, the communication interface 165, the image renderer 170, the eye trackers 160A, 160B, and/or the sensors 155 may be in different locations than shown in FIG. 2.

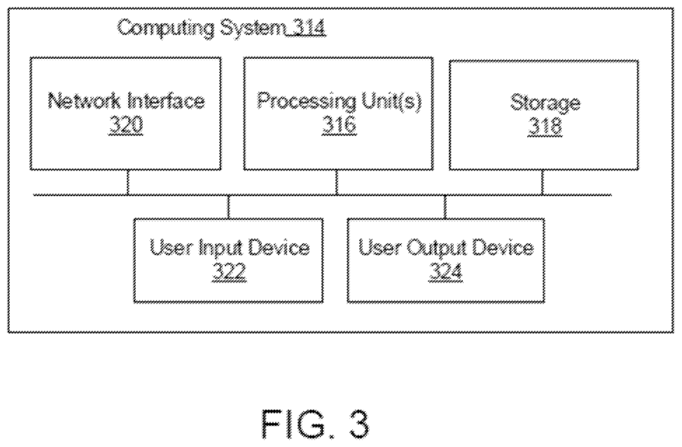

Various operations described herein can be implemented on computer systems. FIG. 3 shows a block diagram of a representative computing system 314 usable to implement the present disclosure, in accordance with an example embodiment. In some embodiments, the console 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

User input device 322 can include any device (or devices) via which a user can provide signals to computing system 314; computing system 314 can interpret the signals as indicative of particular user requests for information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Devices may be limited by their battery (e.g., capacity of the battery). For example, wearable devices may have small batteries, resulting in limited performance (e.g., limited charged life span, frequent charging of the device). Prolonging the battery life, power efficiency, and/or minimizing/reducing power consumption enhances the device performance and/or a user experience. To improve the performance of such devices, the devices may be configured to enter power saving mode(s)/reduced power mode(s). These modes may include wake times in which the device operates at full capacity, and sleep states in which the device operates in a low power mode at limited capacity. Devices, such as HWDs 150 and/or computing devices 110, may share/agree/negotiate their sleep/low power/idle schedule with other devices (such as AP 105). One such sleep mode may be called target wake time (TWT).

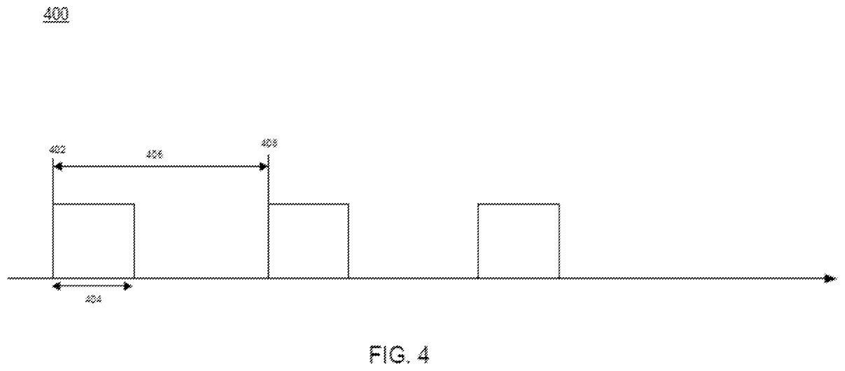

FIG. 4 is a timing diagram 400 showing a wake-up/sleep schedule of a computing device utilizing TWT, according to an example implementation of the present disclosure. The TWT can be a periodic, fixed, wake-up schedule. That is, the device may wake up periodically (e.g., at a fixed, configured time interval/period/cycle) based on the TWT schedule. The TWT schedule reduces energy consumption of the device by limiting the awake time and the associated power consumption of the device.

The TWT start time is indicated by the device (e.g., a portion of its relevant modules/circuitry) waking up at 402. The computing device 110 may wake up for a duration 404 defined by a service period (SP). During the wake time of the TWT schedule (or other sleep schedule), the device (computing device 110 and/or HWD 150) may be in an awake/active state (e.g., the wireless communication module/interface is in a powered-up, ready or wake state) and is able to transmit a signal (e.g., using various contention based procedures, non-contention based procedures, and the like), listen to a medium, and/or receive a signal/transmission. After the SP duration 404, the device may enter a sleep state until the next TWT start time at 408. When the device is inactive or not awake (e.g., the wireless communication module/interface is in a powered-down, low power or sleep state), the device may enter a low power mode or other sleep mode. The device may exist in a sleep state until a time instance/window as specified by the agreed upon sleep schedule (e.g., the next wake start time 408). The interval of time between TWT start time 402 and TWT start time 408 may be considered the SP interval 406.

The TWT schedule may be communicated and/or negotiated using broadcast TWT (bTWT) and/or individual TWT (iTWT) signaling. In some embodiments, to signal iTWT, TWT schedule information may be communicated to particular (individual) devices using a mode such as a Network Allocation Vector (NAV) to protect the medium access of TWT SPs. In contrast, to signal bTWT, in some embodiments, a device (such as AP 105) may schedule TWT SPs with other devices (e.g., computing devices 110 and/or HWDs 150) and may share schedule information in beacon frames and/or probe response frames.

When devices (including computing devices 110 and/or HWDs 150) negotiate and/or agree to scheduled sleep/wake up schedules (e.g., iTWT for a particular/specific devices), the data transmission (e.g., data received by the device and/or data transmitted by the device) becomes more predictable. The device is only expected to receive/transmit data when the device is awake. When the device is awake, the device may expect to receive/transmit data at any time. The device is able to go to sleep because the device does not expect other devices to communicate. The device may conserve power when utilizing a sleep/wake up schedule because the device consumes less power when the device is sleeping/idle/in lower power mode.

In some cases (such as AR/VR applications), a device (such as computing device 110) communicates with one or more entities (e.g., AP 105 and/or HWD 150) on the same wireless communication channel. In these cases, each of the devices (e.g., computing device(s) 110, AP 105, and/or HWD(s) 150) may contend for the same wireless channel and/or there may be an increased chance of data packet collision. When packets collide, the device may wait an amount of time, contend for the wireless channel, and retransmit the data packets. Contention among the devices for the same wireless channel and/or data packet collision may result in increased packet loss (e.g., packets do not arrive at their intended destination), increased latency (e.g., the devices needing to retransmit the data, the devices needing to wait until a next opportunity to transmit their data), and/or jitter in data delivery. Accordingly, the user experience and/or device performance is poor. In these cases, the device performance and/or user performance decreases the more devices that are sharing the same wireless channel. In the AR/VR context for instance, there may be one AP and multiple HWD/computing device pairs sharing the same wireless communication channel.

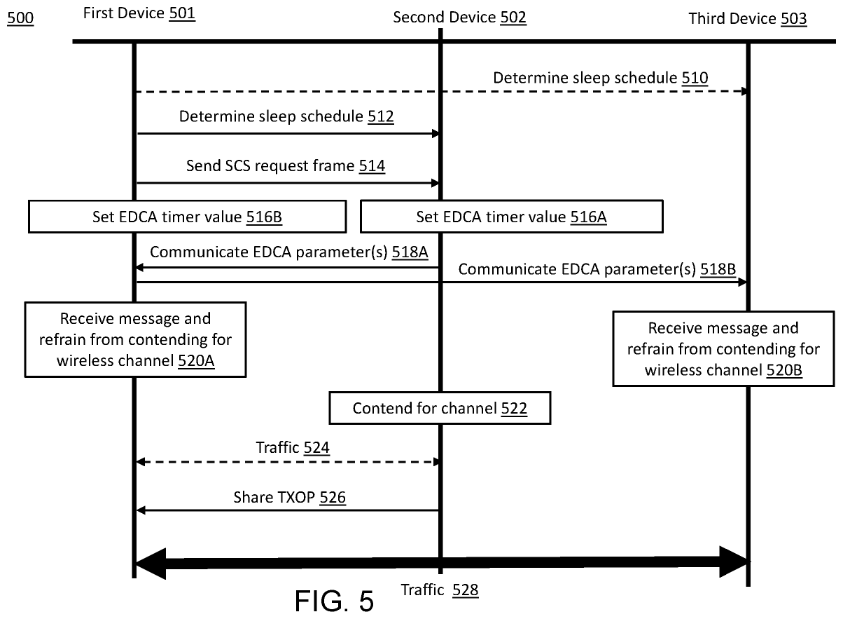

FIG. 5 illustrates an interaction/flow diagram showing a process 500 of coordinating traffic of multiple devices sharing the same wireless communication channel, according to an example implementation of the present disclosure. In some embodiments, the process 500 is performed by a first device 501, a second device 502, and/or a third device 503. The first device 501, second device 502, and third device 503 may be computing device 110, AP 105/soft AP, and HWD 150 respectively. In some embodiments, the process 500 is partially/wholly performed by one or more other entities. In some embodiments, the process 500 includes more, fewer, or different steps than shown in FIG. 5.

In operation 510, the first device 501 may negotiate/determine a sleep schedule/wake up schedule with the third device 503. In some embodiments, the sleep schedule/wake up schedule between the first device 501 and the third device 503 may be preconfigured. For example, the first device 501 and third device 503 may not agree/negotiate a sleep schedule because the first device 501 and third device 503 may already operate according to a sleep schedule/wake up schedule (e.g., the sleep/wake up schedule may be determined/preprogrammed by one or more manufacturers). In some embodiments, the periodicity of sleep schedule/wake up schedule between the first device 501 and the third device 503 may be based on a heartbeat interval (set by the first device 501 and/or third device 503).

In operation 512, the first device 501 may negotiate/determine a sleep schedule/wake up schedule with the second device 502. By determining (e.g., agreeing upon) a sleep schedule/wake up schedule, the first device 501 may ensure that the second device 502 does not transmit to the first device 501 outside of the negotiated/agreed upon time interval. As described herein, the sleep schedule/wake up schedule can enforce data transmission predictability, allowing the devices (e.g., the first device 501 and/or the third device 503) to reduce power consumption. The first device 501 may coordinate the sleep/wake up schedule with the second device 502 according to the sleep/wake up schedule with the third device 503. In some embodiments, the first device 501 may determine the start time of the sleep schedule (e.g., iTWT SP) according to interlink and intralink traffic profiles. Additionally or alternatively, the first device 501 may determine the periodicity of the sleep schedule (e.g., iTWT SP) according to a heartbeat interval (set by the first device 501 and/or third device 503). Additionally or alternatively, the first device 501 may determine to wake up some delta before the third device 503 such that the first device 501 communicates/receives traffic with the second device 502 before the third device 503 wakes up. That is, a time difference (delta) that the first device 501 wakes up before the third device 503 may be relative to the wake up time of the third device 503. It should be appreciated that the remaining operations (e.g., operations 514-528) can occur while the first device 501 and/or the third device 503 are awake.

In operation 514, the first device 501 may send/communicate one or more stream classification service (SCS) request frames to the second device 502. For instance, the one or more SCS request frames may include two SCS request frames, to carry traffic profile information of a link between the first device 501 (e.g., computing device 110) and the second device 502 (e.g., HWD 150), and of another link between the first device 501 and the third device 503. There may be one SCS request frame for intralink traffic profile information, and another SCS request frame for interlink traffic profile information. For instance, a first SCS request frame may be used to indicate the intralink traffic parameters/peer-to-peer traffic parameters to the second device 502 (e.g., the traffic to be communicated between the first device 501 and the third device 503). A second SCS request frame may be used to indicate interlink traffic parameters to the second device 502 (e.g., the traffic to be communicated between the first device 501 and the second device 502). The SCS request frame may include traffic information to be communicated including delay/latency/prioritization information, throughput information, tolerable packet loss, IMU data, a size of the traffic to be communicated, a duration of the traffic to be communicated, etc.

In operation 516, the first device 501 and/or the second device 502 may determine one or more EDCA parameters. EDCA parameters are an example of parameters that may be used to coordinate multiple devices sharing access to a single wireless channel. In some embodiments, the first device 501 and/or the second device 502 may set/determine one or more other parameters configured to coordinate multiple devices sharing access to a single wireless channel. Examples of EDCA parameters include arbitration interframe spacing (AIFS), minimum contention window (CWmin), maximum contention window (CWmax), TXOP, and/or an EDCA timer value. To ensure fairness in medium access, multiple wireless devices may probabilistically or randomly set values of EDCA parameters to compete for access to the wireless link. However, accessing the wireless link in a probabilistic manner to promote fairness may cause latency, increased data packet collision, and/or reduced throughput. Such latency or reduced throughput may not be suitable for latency critical applications such as artificial reality applications. Accordingly, the second device 502 may set EDCA parameters for one or more devices sharing the wireless channel. For example, the second device 502 may utilize the traffic information to be communicated (e.g., received in the SCS request frame at operation 514) to determine a (e.g., sufficient/extended) duration of time for the TXOP.

In an example implementation, the second device 502 (e.g., AP, at 516A) may set the EDCA timer value (e.g., MU-EDCA timer) for the first device 501 (e.g., computing device), while the first device 501 (at 516B) may set an EDCA timer value for a third device 503 (e.g., HWD). The EDCA timer values may indicate a window of time that the first device 501 and/or the third device 503 do not contend for access to the medium. The second device 502 may set an EDCA timer value for the first device 501 to a large value in order to prevent the first device 501 from contending for the wireless channel. The first device 501 may set an EDCA timer value for the third device 503 to a large value in order to prevent the third device 503 from contending for the wireless channel. In some embodiments, an EDCA timer value may extend across the duration of the TXOP. In other embodiments, the EDCA timer value may extend across a portion of the TXOP (e.g., a first portion of the TXOP which may either be an interlink data transfer or intralink data transfer).

As shown in operation 518 (e.g., operation 518A at the first device 501 and operation 518B at the third device 503), the second device 502 may communicate to the first device 501 a first EDCA timer value using a first message, and the first device 501 may communicate to the third device 503 a second EDCA timer value using a second message. As shown in operation 520 (e.g., operation 520A at the first device 501 and operation 520B at the third device 503), the first device 501 and/or the third device 503 may receive the respective messages containing the EDCA timer values and can/should refrain from contending for the wireless channel according to the EDCA timer values. The EDCA timer values can be the same value, in some embodiments.

In operation 522, the second device 502 may contend for the wireless channel. As shown, although there are multiple devices sharing the same wireless channel (e.g., first device 501, second device 502, and third device 503), only the second device 502 may contend for access of the wireless channel because of the high/large/defined EDCA timer value. In some embodiments, the second device 502 may contend for access of the wireless channel using an aggressive access category (e.g., video in/video out, or some other latency sensitive traffic type). The second device 502 may contend for the wireless channel using the traffic information to be communicated/received from the first device 501 in operation 514. That is, the SCS request frame may assist the second device 502 in scheduling the duration of the second device's TXOP such that the duration of the TXOP is sufficient for both intralink communication and interlink communication.

The second device 502 may contend for access to the wireless channel for a duration of time suitable for both interlink communication (e.g., communication between the first device 501 and second device 502) and intralink communication (e.g., communication between the first device 501 and the third device 503). The second device 502 may determine the intralink communication using the traffic information to be communicated received in the SCS frame in operation 514. In some instances, the second device 502 receives the traffic to be communicated as a duration of time requested by the first device 501 to communicate with the third device 503 for intralink data transfer. In some instances, the second device 502 receives the traffic to be communication as a size of traffic to be communicated between the first device 501 and the third device 503. The second device 502 may be configured to determine a duration of time for intralink data transfer based on the size of the traffic to be communicated.

In operation 524, the second device 502 may communicate/receive traffic to/from the first device 501 responsive to the second device 502 winning/obtaining/confirming access to the channel. For instance, the second device 502 may communicate downlink interlink traffic during the TXOP allocated/assigned/won by the second device 502. Additionally or alternatively, the second device may receive uplink interlink traffic from the first device 501, during the TXOP.

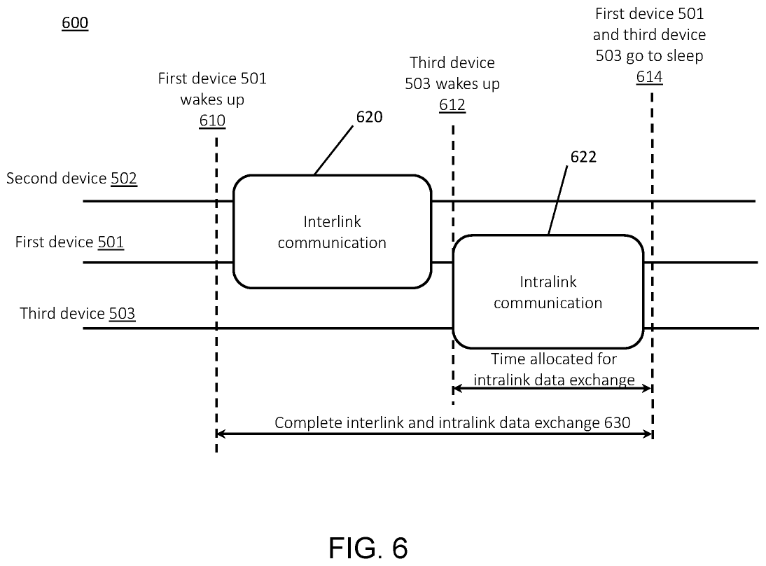

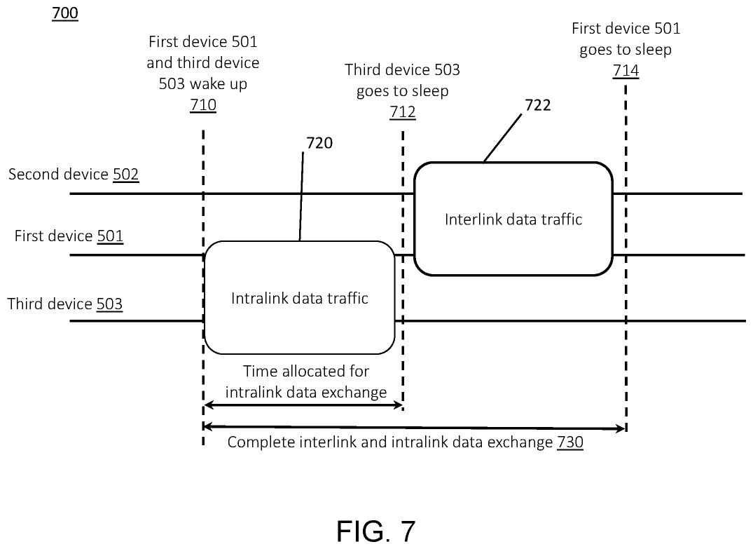

In operation 526, the second device 502 indicates that it is sharing (or is to share) the remaining duration of the TXOP with the first device 501. In some cases, the indication may include a multi-user request to send TXOP sharing (MU-RTS TXS) frame (e.g., of mode 2). The indication may include the duration of time remaining in the TXOP. It should be appreciated that while FIG. 5 illustrates interlink communication between the second device 502 and the first device 501 at operation 524, and subsequently sharing the TXOP in operation 526 (see FIG. 6), in other embodiments, the second device 502 may share the TXOP with the first device 501 (e.g., for communicating intralink traffic) before the first device 501 and second device 502 communicate interlink traffic (see FIG. 7). In the event in which there are multiple pairs of devices (e.g., HWD 150 and computing device 110, third device 503 and first device 501), the second device (e.g., AP 105) may share different TXOPs (and/or different portions of a TXOP) with different first devices.

In operation 528, responsive to the first device 501 receiving the indication that the TXOP of the second device 502 is shared (or is to be shared) with the first device 501, the first device 501 may communicate (e.g., transmit/receive) both interlink traffic and interlink traffic during the single shared TXOP (e.g., communicate traffic with the second device 502 and/or the third device 503). As described herein, the second device 502 may allocate sufficient time in the TXOP that the duration of the TXOP supports/facilitates/allows both interlink communication and intralink communication. Accordingly, the TXOP may be considered to be divided into at least two portions. As illustrated in FIG. 6, a first portion of the TXOP (e.g., interlink communication) occurs at a time before a second portion of the TXOP (e.g., intralink communication). As illustrated in FIG. 7, a first portion of the TXOP (e.g., intralink communication) occurs at a time before a second portion of the TXOP (e.g., interlink communication). The first device 501 may determine the order of the data exchange, e.g., according to the type of application executed (e.g., AR/VR application), a priority of the data (e.g., latency sensitive traffic), a schedule (e.g., a sleep schedule, a preconfigured schedule), and the like.

FIG. 6 illustrates an interaction diagram showing a process 600 of coordinating intralink and interlink communication within one TXOP through TXOP sharing, according to an example implementation of the present disclosure. It should be appreciated that the first device 501 (e.g., computing device 110) has negotiated/obtained a sleep schedule/wake up schedule with the second device (e.g., AP 105) and that the first device 501 (e.g., computing device 110) may have negotiated/predefined a sleep schedule/wake up schedule with the third device 503 (e.g., HWD 150). It should also be appreciated that the second device 502 can set a high EDCA timer value such that the first device 501 can refrain from contending for access to the wireless channel (or are sleeping/in an idle mode/low power mode), and that the first device 501 can set a high EDCA timer value such that the third device 503 can refrain from contending for access to the wireless channel. Accordingly, the second device 502 has won/obtained access to the channel for a TXOP duration 630 sufficient for both interlink communication and intralink communication.

During the TXOP of the second device 502 (or at the beginning of the TXOP of the second device 502), the first device 501 wakes up at 610. The first device 501 and the second device 502 may communicate interlink traffic 620. For example, the second device 502 may communicate downlink traffic to the first device 501. At some point during the interlink communication 620, the second device 502 may indicate to the first device that it is sharing (or is to share) the TXOP. For example, the second device 502 may transmit a MU-RTS TXS frame (e.g., of mode 2) to initiate sharing of the remaining TXOP time with the first device 501. If the MU-RTS TXS frame is mode 2 (e.g., set by the second device), then the first device 501 may transmit uplink traffic to the second device 502 during the interlink communication 620 in the TXOP. In some cases, the first device 501 may not have uplink traffic to transmit to the second device 502.

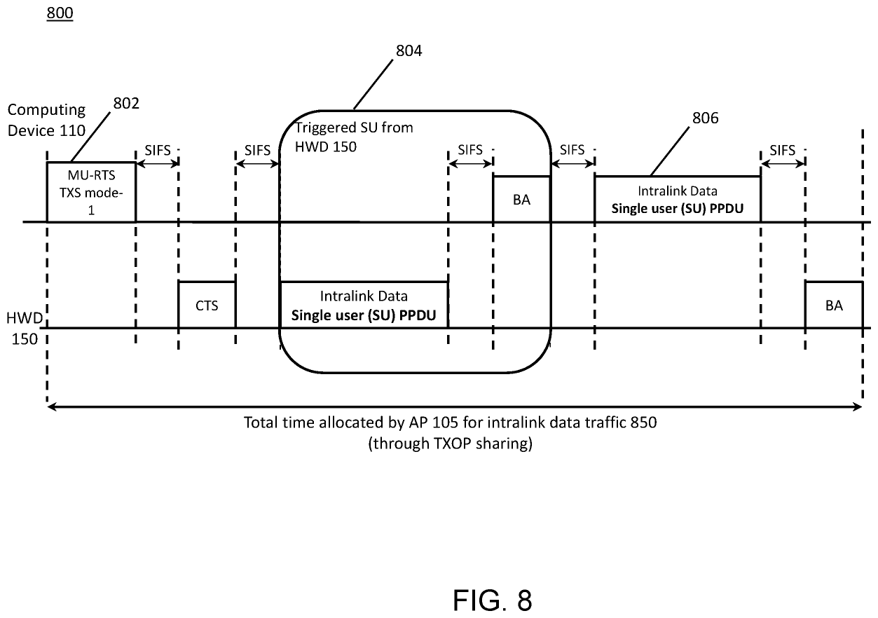

After the interlink communication 620 (e.g., downlink communication from the second device 502 to the first device 501 and/or uplink communication from the first device 501 to the second device 502), the third device 503 may wake up at/near 612. The second device 502 sharing the TXOP with the first device 501 may result in the first device 501 communicating intralink traffic 622 with the third device 503 (e.g., downlink communication from the first device 501 to the third device 503 and/or uplink communication from the third device 503 to the first device 501). The first device 501 may transmit traffic to the third device 503 and/or solicit traffic from the third device 503 during the intralink communication 622. FIGS. 8-11 described herein illustrate ways in which the first device 501 may solicit/trigger traffic from the third device 503 during intralink communication 622.

After the intralink communication 622, the third device 503 and first device 501 may enter their respective sleep states/idle modes/low power modes until the next scheduled wake up time (not shown). The third device 503 and first device 501 may enter the sleep state because the third device 503 and first device 501 have agreed (with each other and/or the second device 502), that no other frames/packets/messages is to be addressed to the first device 501 and/or third device 503 until the next pre-agreed schedule.

FIG. 7 illustrates another interaction diagram showing a process 700 of coordinating intralink and interlink communication within one TXOP through TXOP sharing, according an example implementation of the present disclosure. As described with reference to FIG. 6, it should be appreciated that the first device 501 (e.g., computing device 110) may have negotiated a sleep schedule/wake up schedule with the second device (e.g., AP 105), and that the first device 501 (e.g., computing device 110) may have negotiated/predefined a sleep schedule/wake up schedule with the third device 503 (e.g., HWD 150). It should also be appreciated that the second device 502 can have set a high EDCA timer value for the first device 501 such that the first device 501 may refrain from contending for access to the wireless channel (or are sleeping/in an idle mode/low power mode), and that the first device 501 can have set a high EDCA timer value for the third device 503 such that the third device 503 may refrain from contending for access to the wireless channel. Accordingly, the second device 502 has won/obtained access to the channel for a TXOP duration 730 sufficient for both interlink communication and intralink communication.

During the TXOP of the second device 502 (or at the beginning of the TXOP of the second device 502), the first device 501 and the third device 503 can wake up at 710. The second device 502 may indicate at/near 710 that the TXOP allocated to the second device 502 is being shared (or is to be shared) by the second device 502 with the first device 501. For example, the second device 502 may transmit a MU-RTS TXS. If the MU-RTS TXS frame is mode 2, then the first device 501 may transmit traffic to the third device 503 during peer-to-peer (intralink) communication 720. Additionally or alternatively, the first device 501 may solicit traffic from the third device 503 during the intralink communication 720, as described with reference to FIGS. 8-11.

After the intralink communication 720 (e.g., downlink communication from the first device 501 to the third device 503 and/or uplink communication from the third device 503 to the first device 501), the third device 503 may go to sleep or enter the sleep state/idle mode/lower power mode at/near 712 until the next scheduled wake up time (not shown). After the intralink communication 720, the first device 501 may communicate interlink traffic 722 with the second device 502 (e.g., uplink communication from the first device 501 to the second device 502 and/or downlink communication from the second device 502 to the first device 501)

After the interlink communication 722, the first device 501 may enter the sleep state/idle mode/lower power mode at/near 714 until the next scheduled wake up time (not shown). It should be appreciated that during a first data exchange (e.g., data exchange 630 with reference to FIG. 6), the first device 501 may communicate interlink traffic and then intralink traffic. However, during a second data exchange (e.g., data exchange 730), the first device 501 may communicate intralink traffic and then interlink traffic. The first device 501 may be configured to make such communication decisions based on the sleep schedule with the third device 503, the type of traffic (priority, latency sensitivity, etc) communicated (e.g., during intralink communication or interlink communication), and the like.

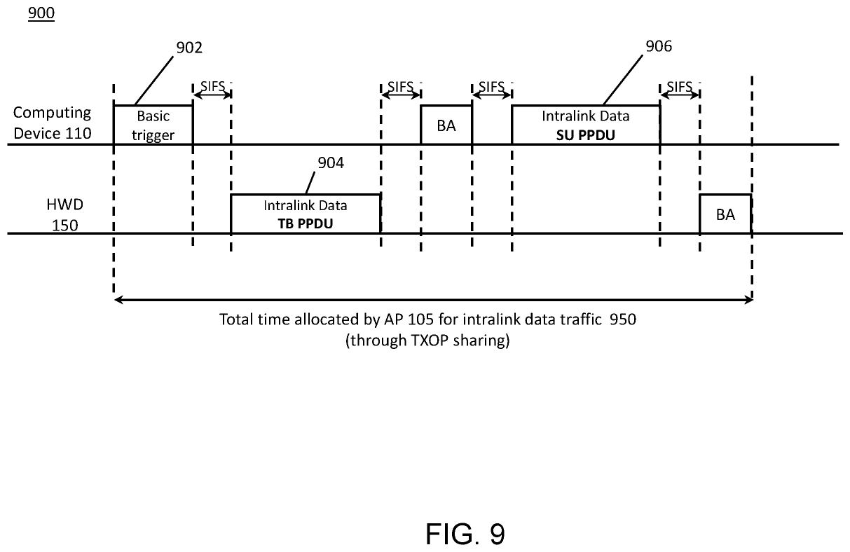

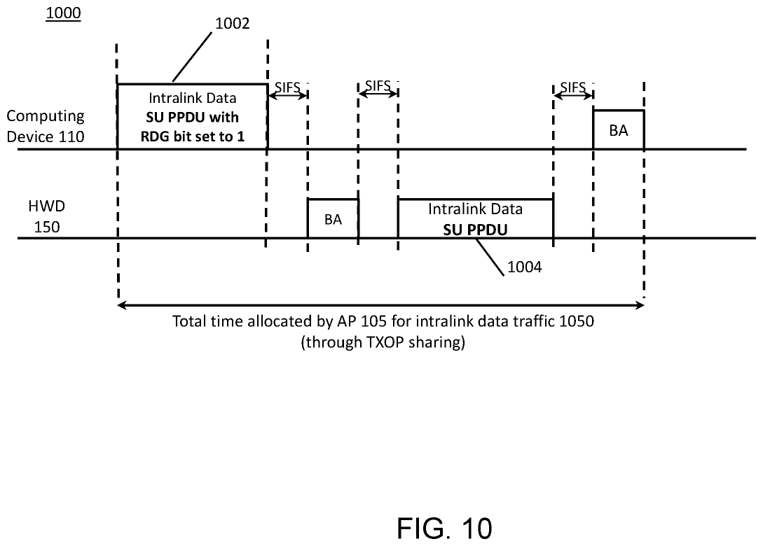

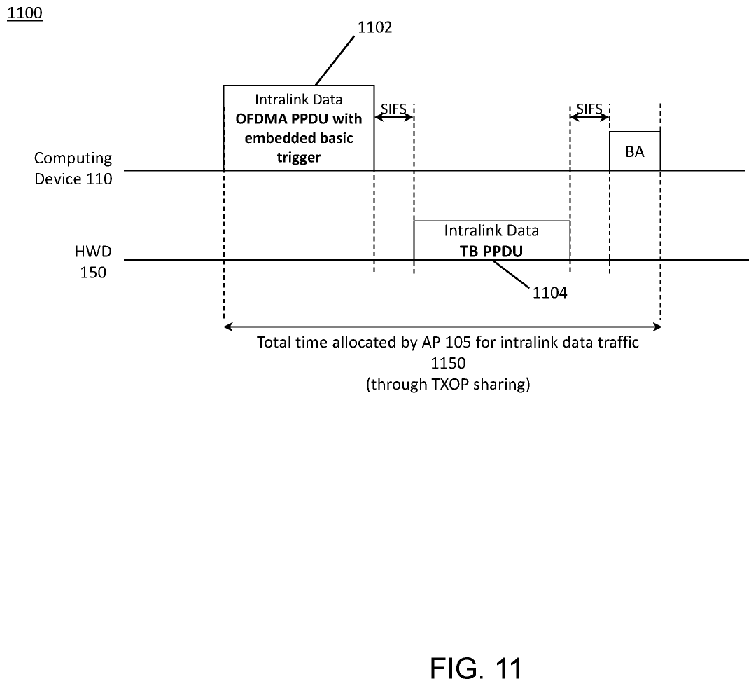

FIGS. 8-11 illustrate different ways in which the computing device 110 and HWD 150 may coordinate traffic during intralink communication, according to an example implementation of the present disclosure. In each of FIGS. 8-11, the computing device 110 and/or HWD 150 do not contend for channel access. The computing device 110 communicates with the HWD 150 using the TXOP shared by the AP 105 (or second device 502). As part of the traffic coordination, the computing device 110 may trigger the HWD 150 that intralink communication is beginning/initiated using various types of messages during the TXOP. As part of the intralink communication, such messages/responses as clear to send (CTS), block acknowledge (BA) and the like may be communicated between the computing device 110 and/or the HWD 150. Moreover, such intralink communication may include spacing between communications such as short interframe space (SIFS). The total time for intralink traffic (e.g., 850 in FIG. 8, 950 in FIG. 9, 1050 in FIGS. 10, and 1150 in FIG. 11) may include such BA, CTS, and SIFS, for instance.

As illustrated in FIG. 8, one example downlink message communicated by the computing device 110 may include an MU-RTS TXS frame 802. When the computing device 110 sets the MU-RTS TXS frame to mode 1, the computing device 110 may solicit intralink data from the HWD 150. This intralink communication may be beneficial for priority/latency sensitive data (e.g., sensor data transmitted from the HWD 150). In response to the MU-RTS TXS frame 802, the HWD 150 may communicate intralink traffic (e.g., uplink data) during 804 using a single user (SU) physical layer protocol data unit (PPDU). In some implementations, the computing device 110 may respond to the HWD 150 with SU PPDUs 806. The computing device 110 and/or HWD 150 may communicate using SU PPDUs in a back and forth fashion/iteratively/reciprocally for the duration of the intralink communication 850. In the example implementation, the HWD 150 may be configured to support at least the seventh generation of Wi-Fi such that the HWD 150 properly interprets the MU-RTX TXS frame 802.

As illustrated in FIG. 9, one example downlink message communicated by the computing device 110 may include a trigger-based (TB) PPDU 902 (e.g., a basic trigger). When the computing device 110 communicates the trigger to the HWD 150, the computing device 110 may solicit intralink data from the HWD 150. This intralink communication may be beneficial for priority/latency sensitive data (e.g., receiving, by the computing device 110, sensor data from the HWD 150). In response to the basic trigger 902, the HWD 150 may communicate intralink traffic (e.g., uplink data) during 904 using TB PPDU. In some implementations, the computing device 110 may respond to the HWD 150 with SU PPDUs 906. The computing device 110 and/or HWD 150 may iteratively/reciprocally communicate for the duration of the intralink communication 950. In the example implementation, the HWD 150 may be configured to support at least the sixth generation of Wi-Fi such that the HWD 150 can interpret the TB PPDU. In some implementations, interpreting the TB PPDU may result in the consumption of additional computational resources by the HWD 150 to process the TB PPDU.

As illustrated in FIG. 10, one example downlink message communicated by the computing device 110 may include a SU PPDU packet with the reverse direction grant (RDG) bit set 1002 in a high throughput, very high throughput and/or high efficiency control field (not shown). Setting/enabling RDG allows the computing device 110 and the HWD 150 to initiate a reverse direction frame exchange in which the HWD 150 responds to the computing device 110. In an example, after the HWD 150 transmits a BA acknowledging receipt of the SU PPDU packet with the RDG bit set 1002, the HWD 150 may send its intralink data to the computing device 110 in a SU PPDU 1004. The computing device 110 and/or HWD 150 may iteratively/reciprocally communicate for the duration of the intralink communication 1050. In an example implementation, the HWD 150 may be any legacy compliant device (e.g., the HWD 150 may be configured to support at least the fifth generation of Wi-Fi). The communication of the SU PPDU packet may involve less overhead/processing performed by the HWD 150 as compared to receiving the MU-RTS TXS and/or TB PPDU as described in FIGS. 8-9.

As illustrated in FIG. 11, one example downlink message communicated by the computing device 110 may include an orthogonal frequency division multiple access (OFDMA) PPDU with an embedded basic trigger 1102. The HWD 150 may interpret the OFDMA PPDU with the embedded basic trigger 1102 as an implicit trigger to communicate intralink data (as compared to explicit triggers such as the MU-RTS, TXS frame, TB PPDU, and/or SU PPDU packet with RDG bit set, described in FIGS. 8-10 respectively). In an example, the HWD 150 may respond to the OFDMA PPDU with the embedded basic trigger 1102 using a TB PPDU 1104. The computing device 110 and/or HWD 150 may iteratively/reciprocally communicate for the duration of the intralink communication 1150. In the example implementation, the HWD 150 may be configured to support at least the sixth generation of Wi-Fi. The communication of the OFDMA PPDU packet may involve less overhead/processing performed by the HWD 150 as compared to receiving the MU-RTS TXS, TB PPDU, and/or SU PPDU with RDG bit set, as described in FIGS. 8-10 respectively.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

1. A method comprising:
sending, by a first wireless communication device to a second wireless communication device, at least one stream classification service (SCS) request frame including information of traffic to be communicated between the first wireless communication device and at least one of: the second wireless communication device or a third wireless communication device, wherein the first wireless communication device, the second wireless communication device and the third wireless communication device share a wireless communication channel; and
communicating, by the first wireless communication device responsive to receiving an indication that a transmission opportunity (TXOP) of the second wireless communication device is shared with the first wireless communication device, with the second wireless communication device on a first link during a first portion of the TXOP, and with the third wireless communication device on a second link during a second portion of the TXOP.

2. The method of claim 1, comprising:
determining, by the first wireless communication device in communication with the second wireless communication device, a target wake time (TWT) schedule.

3. The method of claim 2, comprising:
determining, by the first wireless communication device in communication with the third wireless communication device, a wake up schedule.

4. The method of claim 3, wherein the first wireless communication device determines the TWT schedule according to the wake up schedule.

5. The method of claim 1, wherein the indication comprises a multi-user request to send TXOP sharing (MU-RTS TXS) frame.

6. The method of claim 1, comprising:
receiving, by the first wireless communication device, from the second wireless communication device, a message including an enhanced distribution channel access (EDCA) timer value; and
refraining from contending for the wireless communication channel, by the first wireless communication device, according to the EDCA timer value.

7. The method of claim 1, comprising:
triggering by the first wireless communication device, the third wireless communication device via a message, the message communicated to the third wireless communication device during the TXOP.

8. The method of claim 7, wherein the message comprises one of an MU-RTS TXS frame, a trigger based physical layer protocol data unit (PPDU), a single user PPDU with a set reverse direction grant (RDG) bit, or an orthogonal frequency division multiple access (OFDMA) PPDU embedded basic trigger.

9. The method of claim 1, wherein the first portion of the TXOP occurs at a time before the second portion of the TXOP.

10. The method of claim 1, wherein the second portion of the TXOP occurs at a time before the first portion of the TXOP.

11. A wireless communication device comprising:
a transceiver; and
at least one processor configured to:
send, via the transceiver, at least one stream classification service (SCS) request frame to a second wireless communication device including information of traffic to be communicated between the wireless communication device and at least one of: the second wireless communication device or a third wireless communication device, wherein the wireless communication device, the second wireless communication device, and the third wireless communication device share a wireless communication channel; and
communicate, responsive to receiving an indication that a transmission opportunity (TXOP) of the second wireless communication device is shared with the wireless communication device, via the transceiver with the second wireless communication device on a first link during a first portion of the TXOP, and with the third wireless communication device on a second link during a second portion of the TXOP.

12. The wireless communication device of claim 11, wherein the at least one processor is configured to determine a target wake time (TWT) schedule with the second wireless communication device.

13. The wireless communication device of claim 12, wherein the at least one processor is configured to determine a wake up schedule with the third wireless communication device.

14. The wireless communication device of claim 13, wherein the at least one processor is configured to determine the TWT schedule according to the wake up schedule.

15. The wireless communication device of claim 11, wherein the indication comprises a multi-user request to send TXOP sharing (MU-RTS TXS) frame.

16. The wireless communication device of claim 11, wherein the at least one processor is configured to:
receive, via the transceiver from the second wireless communication device, a message including an enhanced distribution channel access (EDCA) timer value; and
refrain from contending for the wireless communication channel, according to the EDCA timer value.

17. The wireless communication device of claim 11, wherein the at least one processor is configured to: trigger the third wireless communication device via a message sent via the transceiver, the message communicated to the third wireless communication device during the TXOP.

18. The wireless communication device of claim 11, wherein the message comprises one of an MU-RTS TXS frame, a trigger based physical layer protocol data unit (PPDU), a single user PPDU with a set reverse direction grant (RDG) bit, or an orthogonal frequency division multiple access (OFDMA) PPDU embedded basic trigger.

19. The wireless communication device of claim 11, wherein the first portion of the TXOP occurs at a time before the second portion of the TXOP, or, wherein the second portion of the TXOP occurs at a time before the first portion of the TXOP.

20. A non-transitory processor-readable medium containing processor-readable instructions, such that, when executed by one or more processors of a wireless communication device, cause the one or more processors to:
send, via a transceiver, at least one stream classification service (SCS) request frame to a second wireless communication device including information of traffic to be communicated between the wireless communication device and at least one of: the second wireless communication device or a third wireless communication device, wherein the wireless communication device, the second wireless communication device, and the third wireless communication device share a wireless communication channel; and
communicate, responsive to receiving an indication that a transmission opportunity (TXOP) of the second wireless communication device is shared with the wireless communication device, via the transceiver with the second wireless communication device on a first link during a first portion of the TXOP, and with the third wireless communication device on a second link during a second portion of the TXOP.
